(19) United States
(12) Patent Application Publication
(10) Pub. No.: US 2011/0218908 A1
(43) Pub. Date: Sep. 8, 2011

(54) Discount Funded Savings

(76) Inventor: Timothy P. Johnson, Pine Mountain, GA (US)

(21) Appl. No.: 12/891,404

(22) Filed: Sep. 27, 2010

Related U.S. Application Data
(60) Provisional application No. 61/246,148, filed on Sep. 27, 2009.

(51) Int. Cl. G06Q 40/00

(52) U.S. Cl. 705/39

(57) ABSTRACT

Disclosed is a method and system for Discount Funded Savings wherein an account is funded by the savings generated from the use of coupons or retailer discounts.

### CROSS-REFERENCE TO RELATED APPLICATIONS

This application claims priority to U.S. Provisional Patent Application No. 61/246,148, filed Sep. 27, 2009, which is incorporated herein by reference in its entirety.

### STATEMENT REGARDING FEDERALLY SPONSORED RESEARCH OR DEVELOPMENT

Not applicable

### REFERENCE TO A “SEQUENTIAL LISTING,” A TABLE, OR A COMPUTER PROGRAM LISTING APPENDIX SUBMITTED ON A COMPUTER DISC

Not applicable

### REFERENCES SITED [REFERENCED BY] U.S. PATENT DOCUMENTS

| | | |
|---|---|---|
| 4,419,572 | December 1983 | Von Geldern |
| 4,521,677 | June 1985 | Sarwin |
| 4,780,599 | October 1988 | Baus |
| 4,882,675 | November 1989 | Nichtberger et al |
| 4,949,256 | August 1990 | Humble |
| 5,025,372 | June 1991 | Burton et al |
| 5,056,019 | October 1991 | Schultz et al |
| 5,091,634 | February 1992 | Finch et al |
| 5,128,520 | July 1992 | Rando et al |
| 5,173,851 | December 1992 | Off et al |
| 5,185,695 | February 1993 | Pruchnicki |
| 5,201,010 | April 1993 | Deaton et al |
| 5,245,533 | September 1993 | Marshall |
| 5,353,218 | October 1994 | De Lapa et al |
| 5,687,322 | November 1997 | Holda-Fleck |
| 5,729,693 | March 1998 | Holda-Fleck |

### DESCRIPTION

The invention relates to methods and systems for creating and funding Discount Funded Savings Accounts wherein the accounts are funded by savings from use of coupons or retailer discounts. Said Accounts may be interest-bearing accounts. Furthermore, said Accounts may be created for the consumer as a part of the invention or may be pre-existing accounts owned by the consumer. Further still, the funding of the accounts may be determined by the consumer on each event at the retailer, wherein an “event” is defined as any action that results in funds being made available to the consumer due to savings from the use of a coupon or a retailer discount.

### BACKGROUND OF THE INVENTION

The existing use of coupons allows for the consumer to make a purchase of a specific item and present a coupon to the cashier for the item. The cashier subtracts the value of the coupon from the total and asks the consumer to pay the remaining balance. The existing use of discounts allows for the consumer to make a purchase of a specific item and the retailer discounts the purchase based on its discounted value, and then asks the consumer to pay the remaining balance.

Existing methods that consumers use to save money are for the consumer to either make a deposit at their bank, or have funds deposited into their account through their employer. Many consumers are unable or unwilling to save. Some consumers are unable to save because they do not have a bank account, or because they are physically not able to get to the bank. Other consumers are unwilling to save because of many reasons such as an inability to see any real savings accumulated, and that the bank is not a place that they frequent.

A drawback of the existing art is that it does not allow the consumer to pay the original retail value and have the difference between the original value and the discounted value remitted in the form of a direct, electronic deposit into an account. The consumer may accumulate funds in small increments, over time. The consumer may generate additional funds by placing the funds in an interest bearing account. Further, the retailer or bank may hold funds for a number of consumers, aggregating their funds, and generate revenue for themselves and/or the consumer by investing the funds in interest bearing vehicles. The retailer or bank may also earn revenue by charging fees to the consumer for servicing the account. Furthermore, the retailer may earn revenue by reducing the net savings of the coupons by a percentage, keeping the discount for themselves.

It would therefore be advantageous to have a method and system allowing the consumer to pay the original total, having the savings deposited into an account thereby addressing the shortcomings described above. It would be an advantage to provide a method and system allowing the consumer to control the adding of funds to his account, thereby accumulating funds until needed. It would be advantageous to enable the consumer to control the removing of funds from his account. A further advantage would be to enable consumers who otherwise do not have bank accounts to have access to an account to overcome the shortcomings as described above.

Another advantage of the invention over existing art is that it would simplify the process of saving eliminating the need to fill out a deposit slip, or drive to the bank. A further advantage is that the consumer could deposit funds at a location which is a normal part of their daily activities such as a grocery store.

These and other drawbacks exist to the aforementioned alternatives.

### SUMMARY

The object of the invention is to overcome these and other drawbacks in existing coupon and discount methods, processes, and schemes.

A further objective of the invention is to provide a method and system which allows the consumer to create an account for receipt of the funds.

A further objective of the invention is to provide a method and system which allows the consumer to direct the depositing of funds into the account.

These and other objects of the invention are accomplished according to the various embodiments of the invention. One of the embodiments of the invention provides a method of creating an account, providing access and control of the account to the consumer, whereby the account is funded at the direction of the consumer, and funds are accessible by the consumer. In this embodiment the account's funds are kept separate from all other account's funds.

Another embodiment of the invention provides a method of creating accounts on behalf of consumers, providing access and control of the account to the consumers, whereby the accounts are funded at the direction of the consumers, and funds are accessible by the consumers. In this embodiment the account's funds are aggregated and kept in a funds pool with funds from all other account, but may be reported and delivered to each consumer on an individual basis upon request.

Another embodiment of the invention provides a system for creating and managing the accounts, the calculating of the funds to be deposited, and the funding of the accounts. The system may comprise a processor for creating an account in a database. A consumer may provide instructions for the processor to manage the funds in the account.

Other objects and advantages exist for the present invention.

### BRIEF DESCRIPTION OF THE DRAWINGS

FIG. 1 shows a flowchart for funding a Discount Funded Savings Account of an embodiment of the invention.

FIG. 2 illustrates a schematic of an embodiment of a system to be used with a Discount Funded Savings Account.

### DETAILED DESCRIPTION OF THE DRAWINGS

The present invention is described in relation to a Discount Funded Savings Account created for a consumer. In this environment, the present invention provides for the funding of an account by a plurality of systems and means as initiated by the consumer, through a plurality of retailers, wherein the funds are created by accumulating the savings from retailer or store coupons, or from retailer discounts, and applying the savings as a deposit to the account. The consumer may initiate the depositing of funds to the account, the withdrawal of funds from the account, and may receive information about the activity related to the account.

For purposes of explaining the present invention, an embodiment of the present invention is set forth. A Discount Funded Savings Account may be used by a consumer to accumulate savings. Each Discount Funded Savings Account may have its funds held separately from all other accounts, or may have its funds held separately as sub-accounts which are correlated to a master account, or may have its funds held together in a centralized account wherein all funds are aggregated. The consumer may fund the Discount Funded Savings Account each time that he makes a purchase at a retailer who is enabled to calculate the savings and remit the funds to an account. A consumer may obtain the balance of the Discount Funded Savings Account, may withdraw funds from the account, and may inquire about the transactions related to the Discount Funded Savings Account.

The present invention will now be described in more detail.

According to an embodiment of the invention, a Discount Funded Savings Account is an account into which the consumer may initiate the placement of funds, and may access other information associated with the account, such as the balance of the account and the transactions that have occurred in connection with the account. A consumer may initiate the withdrawal of funds from the account, and may access other information associated with the account, including the balance in the account and various transactions that have occurred with the account.

According to an embodiment of the invention, a retailer may calculate the amount of funds available to be deposited to an account.

According to an embodiment of the invention, a consumer may initiate a deposit of the value calculated, placing the funds into the Discount Funded Savings Account. As a further embodiment of the invention, a retailer may be enabled to make the deposit, on behalf of the consumer into a Discount Funded Savings Account; the Discount Funded Savings Account being either an account created for the consumer, or a pre-existing account owned by the consumer, or an account held at the retailer or bank for the aggregation of multiple consumers' funds.

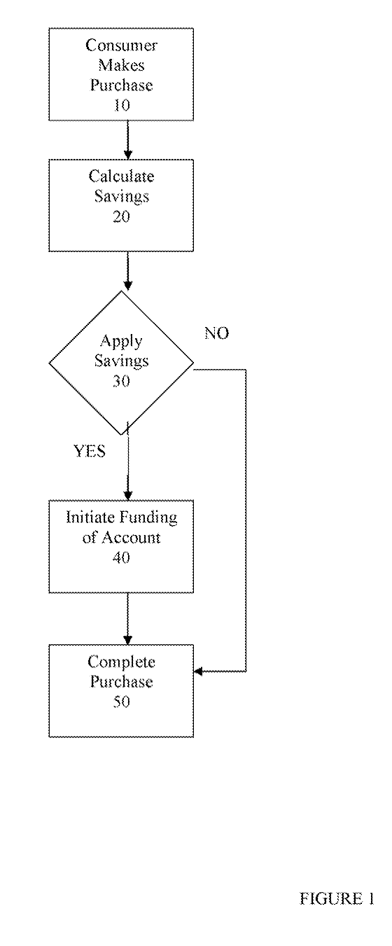

FIG. 1 illustrates a flow chart for funding an account using savings from coupons and/or discounts according to an embodiment of the invention.

According to an embodiment, a consumer makes a purchase at a retailer that is enabled to calculate savings and remit deposits to an account at step 10. Interest may be generated by advertising, such as radio and television commercials, internet advertisements, or direct mailing solicitation, such as through regular mail or through e-mail. Interest may also be generated through previous relationship with the retailer. Other methods for interesting potential consumers may also be used.

At step 20 the retailer calculates the amount available for funding to the Discount Funded Savings Account. The calculations methods may include, but are not limited to, (a) adding the values of all of the in-store coupons presented, (b) adding the values of all regional and national retailer coupons presented, (b) adding the values of all of the other discounts allowable. The cumulative values of all coupons and discounts represent the total funds available for depositing.

At step 30, the consumer decides to apply the available funds to the Discount Funded Savings Account or not. If the consumer decides not to apply the funds to the Discount Funded Savings Account, then the transaction is completed at step 50 by having the total amount due to the retailer reduced by the amount previously calculated as available for depositing. If the consumer decides to apply the funds to the Discount Funded Savings Account, then at step 40, the retailer initiates the funding of the Discount Funded Savings Account.

Initiating the funding of a Discount Funded Savings Account may include ensuring that applicable government regulations are properly followed, providing interface access between the appropriate mechanisms of all parties, e.g. consumer, retailer, and bank, and ensuring that each party has the appropriate hardware and software to enable interaction with the other parties as may be necessary. Other implementation may also be required. The account holds the funds designated by the consumer. The account may be a designated and/or defined as a master account, a correlation account, custodial accounts, single/individual accounts, funding/activity accounts, or other account at the discretion of the consumer. According to an embodiment of the invention, a consumer may add funds to the account through enabled retailers as desired. As a further embodiment of the invention the consumer may also add his own funds to his account using traditional means such as by Direct Deposit via ACH, wire transfer, cash deposit, and transferring funds from another account. Other methods for funding a Discount Funded Savings Account may be used.

A Discount Funded Savings Account may be given a unique account number which may be printed or embossed on a notice or an account identification card along with a consumer's name, as well as how savings and funding calculations are performed and funding instructions. A Discount Funded Savings Account may also be affiliated with financial institutions, debit and credit networks, businesses, and retailers. Identification indicia of one or any of these affiliated entities may be displayed on the notice or card.

By way of example, a consumer elects to apply the calculated savings to the Discount Funded Savings Account, through the enabled retailer, via an automated-clearinghouse (ACH) deposit (DDP). The DDP includes a routing/transit number, a Discount Funded Savings Account number, and a deposit amount. The DDP is sent through the ACH. The DDP is sent to system 100, where it is processed as a credit to the appropriate Discount Funded Savings Account in processing module 110.

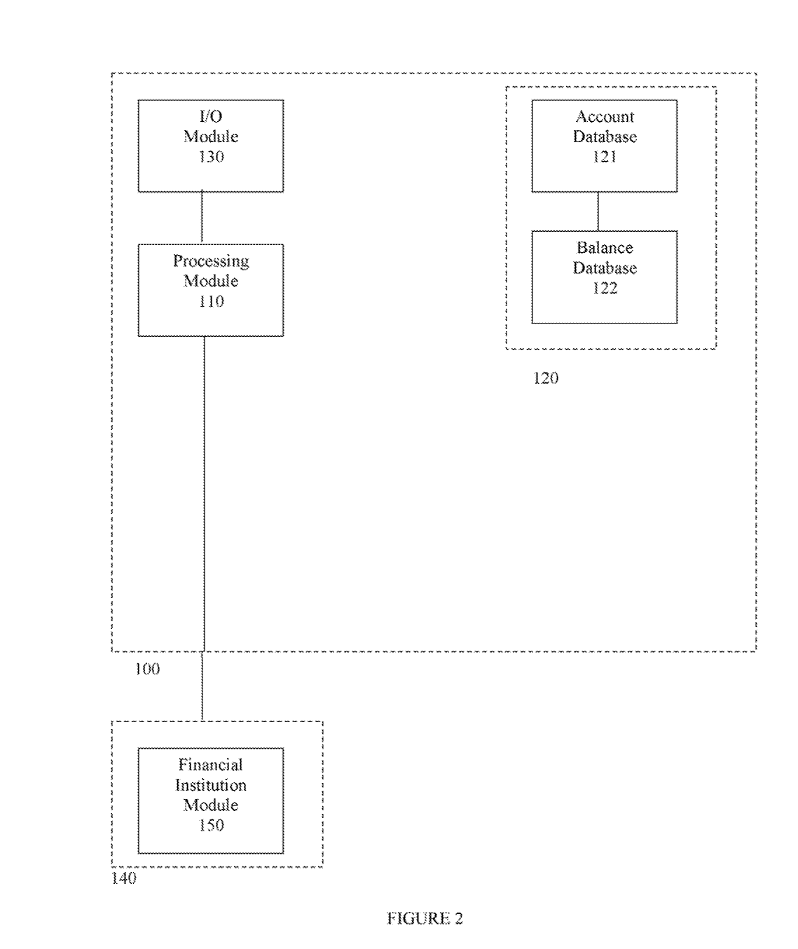

FIG. 2 illustrates a schematic system to support a Discount Funded Savings Account according to an embodiment of the invention. System 100 comprises a processing module 110, a database module 120, and an input/output (I/O) module 130.

According to an embodiment of the invention, processing module 110 may act to coordinate information flow in system 100 and, according to an embodiment of the invention, may be a central processing unit (CPU) of a computer. According to an embodiment of the invention, database module 120 may comprise an account database module 121 and a balance database module 122. An account database module 121 may be responsible for storing information related to accounts associated with each Discount Funded Savings Account, such as an account number and the name of the accountholder. Other information may also be stored in an account database module 121.

Balance database module 122 may be responsible for storing information about the account balance. Processing module 110 may instruct balance database module 122 to be updated to increase or decrease the amount of funds in a Discount Funded Savings Account. Funds may be increased when a consumer seeks to deposit funds into an account. Funds may be decreased if a consumer initiates a withdrawal of funds. Other information may also be stored in balance database module 122.

Input/Output (I/O) module 130 may permit a consumer or retailer, collectively a User, to connect with processing module 110, and transmit and receive information. According to an embodiment of the invention, a User may use I/O module 130 to request information about one or more Discount Funded Savings Accounts. Processing module 110 may access account database module 121, retrieve the requested information, and transmit the information to a User via I/O module 130. Other information may also be transmitted and/or requested. I/O module 130 may be a direct network connection, such as a dedicated line, or an indirect connection such as through the internet (World Wide Web) and a browser. Other methods of connection may also be used.

Processing module 110 may be connected to a financial institution 150 through System 140. Instructions in module 110, through processing modules 100 and 140, may initiate a deposit of funds to a financial institution 150, to a Discount Funded Savings Account by depositing funds in the form of a check, or electronic transfer. Other methods of performing remittances may also be used.

As noted previously, a Discount Funded Savings Account may provide for funds to be accumulated by a consumer for future use. According to an embodiment of the invention, a Discount Funded Savings Account may resemble a traditional bank account, or may be an actual bank account, but the method for accumulating funds (i.e. through coupons and store discounts), as well as the method for depositing funds (i.e. at retailers where they already shop), and the elimination of the need for a deposit slip, simplify the process.

Such a method and system may increase savings by allowing the consumer to accumulate funds in small increments, over time. The invention allows that the consumer may generate additional funds by placing the funds in an interest bearing account. Further, the retailer or bank May hold funds for a number of consumers, aggregating their funds, and generate revenue for themselves and/or the consumer by investing the funds in interest bearing vehicles. The retailer or bank may also earn revenue by charging fees to the consumer for servicing the account. Furthermore, the retailer may earn revenue by reducing the net savings of the coupons by a percentage, keeping the discount for themselves.

For a retailer, and a Financial Institution, a Discount Funded Savings Account may provide revenue through fees such as a monthly account maintenance fee, a transaction fee, or a service fee paid by consumers. According to an embodiment of the invention, interest may be earned on the balance of funds in a Discount Funded Savings Account. Interest may be awarded to any of the participants such as a retailer, bank, or consumer, or may be awarded to any other entity.

According to a specific embodiment of the present invention, system 100 may comprise components of a software system. System 100 may operate on a network and be connected to other systems sharing a common database or databases. Other hardware arrangements may also be provided.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

What is claimed is:

1. A method for establishing and managing a Discount Funded Savings Account, the method comprising the following steps:
a. creating an account for each subscribing consumer
b. calculating the amount available for funding of the account based on savings generated from the use of coupons or retailer discounts
c. funding the account based on consumer instructions and the calculated savings generated from the use of coupons or retailer discounts

2. A system for establishing and managing a Discount Funded Savings Account, the system comprising the following steps:
a. creating an account for each subscribing consumer
b. calculating the amount available for funding of the account based on savings generated from the use of coupons or retailer discounts
c. funding the account based on consumer instructions and the calculated savings generated from the use of coupons or retailer discounts
